(19) United States
(12) Patent Application Publication
(10) Pub. No.: US 2025/0178669 A1
(43) Pub. Date: Jun. 5, 2025

(54) SENSOR ASSEMBLY FOR A BELT DRIVE

(71) Applicants: HELLA GmbH & Co. KGaA, Lippstadt (DE); NSK Europe Limited, Maidenhead Berkshire (GB); HANGZHOU KINGWAY TECHNOLOGY CO., LTD., Hangzhou (CN)

(72) Inventors: Henning IRLE, Lippstadt (DE); Patrick FRIEDEL, Verl (DE); Christian Michael STRAUB, Frankfurt am Main (DE); Edwin BREUNING, Denkendorf (DE)

(21) Appl. No.: 18/843,738

(22) PCT Filed: Mar. 14, 2022
(86) PCT No.: PCT/EP2022/056434

§ 371 Date: Sep. 4, 2024

(51) Int. Cl. B62D 15/02; B62D 5/04; G01B 7/315

(52) U.S. Cl. CPC B62D 15/0225; B62D 5/0448; B62D 5/0496; G01B 7/315

(57) ABSTRACT

A belt drive comprises a first pulley with a first diameter and a second pulley with a second diameter as well as a belt which is arranged in each case on a lateral surface of the first and the second pulley and is configured to transmit a rotational movement of the first pulley to the second pulley. Furthermore, the belt drive has a first sensor assembly, which is arranged and configured to detect a rotational position of the first pulley, and a second sensor assembly, which is arranged and configured to detect a rotational position of the second pulley. The first diameter corresponds to a first integer multiple of a unit length and the second diameter corresponds to a second integer multiple of the same unit length, wherein the first and second integer multiples of the unit length are coprime.

A sensor assembly for a belt drive and a method for determining the rotational position of pulleys are described here.

Electric drives for the steering of motor vehicles are known, for example, for power steering systems (Electric Power Steering, EPS). In the case of an axis-parallel drive (APA), a so-called “power pack”, which comprises a motor unit and a control or regulation system in the form of an electronic data processing device/unit (ECU), can be coupled via a belt drive with a ball screw drive (KGT), which converts a rotational movement of the motor unit into a translational movement to influence the toe angle of the vehicle wheels.

The belt drive, which couples the “power pack” or the motor unit with the ball screw drive, usually has two pulleys and a belt. To improve known power steering systems, but also to implement fully electronically assisted steering systems for motor vehicles (steer by wire, SBW), it is necessary to determine a current or actual toe angle of the wheels influenced by the steering in order to correctly implement a steering movement for the motor vehicle initiated by the driver of the motor vehicle by means of corresponding control or regulation of the motor unit.

In principle, it is possible to use inductive, capacitive, magnetic and/or optical sensors to determine the rotational position of the pulleys of the belt drive, which couples the power pack or the motor unit to the ball screw drive, and thereby draw conclusions about the current toe angle of the wheels influenced by the steering. In practice, however, optical sensors are uncommon due to contamination of the sensors and pulleys and/or a lack of accuracy. The most precise measurement results can be achieved using inductive sensors.

However, one problem with the detection of a current o r actual rotational position of the pulleys is that a specific rotational position of the two pulleys of the belt drive does not necessarily correspond unambiguously to a specific toe angle of the wheels influenced by the steering. Consequently, the actual or current toe angle of the wheels influenced by the steering can only be determined by determining the rotational positions of the pulleys if the detection of the rotational positions of the pulleys is supplemented by a sensor detection directly on the wheels or at least by an evaluation of the detection history of the rotational positions of the pulleys.

On the one hand, the former is associated with additional technical effort and thus relativizes the advantages associated with detecting the rotational position of the pulleys for regulating or controlling the steering. The latter presupposes that the recording history is always available, i.e. also when the vehicle starts up, and that a memory always provides the history data at the same time as the sensor recording. If the recordings of past rotational position detections are not available, for example when the vehicle starts up, it is not possible to reliably determine a current toe angle of the wheels influenced by the steering based solely on the rotational position of the pulleys. Safe control of the vehicle is therefore not possible in this situation. Furthermore, a tire change, for example, can also lead to an interruption and/or falsification of a recorded detection history, which makes subsequent reliable determination of an actual steering angle based on a recorded rotational position of the pulleys of a steering system impossible.

The technical task is therefore to provide an improved belt drive for a motor vehicle steering system with a sensor system which enables the determination of a rotational position of the pulleys of the belt drive and their unambiguous assignment to a specific current toe angle of the wheels of the motor vehicle influenced by the steering system over the entire adjustment range of the steering system. Furthermore, a corresponding method is also to be provided, which enables the determination of a rotational position of the pulleys of the belt drive and their unambiguous assignment to a specific current toe angle of the wheels of the motor vehicle influenced by the steering over the entire actuating range of the steering.

These tasks are solved by a device according to claim 1 and a method according to the independent method claim. Advantageous embodiments are defined by the further claims.

The belt drive has at least a first pulley with a first diameter and a second pulley with a second diameter. Furthermore, the belt drive has a belt which is arranged in each case on a lateral surface of the first and second pulley and is configured to transmit a rotational movement of the first pulley to the second pulley.

A first sensor assembly is arranged and configured to detect a rotational position of the first pulley. Furthermore, a second sensor assembly is arranged and configured to detect a rotational position of the second pulley.

The first diameter corresponds to a first integer multiple of a unit length. A unit length can be, for example, a millimeter, a centimeter, an inch or another measure of length of any length. In other words, the first pulley has a diameter whose length or amount can be expressed as the product of a natural number and a selected unit length, for example a centimeter or an inch or another unit of length of any length. In one example, the first pulley may have a diameter of 31 units of length, for example a diameter of 31 millimeters.

The second diameter corresponds to a second integer multiple of the same unit length. For example, the second pulley can have a diameter of 97 units of length, for example a diameter of 97 millimetres.

The first and second integer multiples of the unit length are different from each other and are coprime. For example, 31 and 97 are natural numbers that are different from each other and are coprime, i.e. have no common natural divisor beyond the number 1.

In other words, it can be described that the size ratio between the first pulley and the second pulley and/or the length ratio between the first diameter and the second diameter corresponds to a ratio of two different natural numbers to each other, wherein the two different natural numbers have no common natural divisor other than the number 1.

Optionally, the first integer multiple and/or the second integer multiple may correspond to a prime number or the product of a first and/or second unit length with a prime number. In other words, the diameter of the first and/or the second pulley may each correspond to a product of any unit length of any length and a natural number, in particular a prime number. This ensures that the first integer multiple and the second integer multiple of the unit length can never have a common natural divisor.

The first sensor assembly can have a position sensor that detects without contact, in particular a position sensor that detects without contact and inductively. Furthermore, the second sensor assembly can also have a contactless position sensor, in particular a contactless and inductive position sensor. For example, the first and/or second sensor assembly may have a CIPOS® sensor that determines the rotational position of the first and/or second pulley.

Alternatively or additionally, the first sensor assembly and/or the second sensor assembly can also have capacitive, magnetic and/or optical sensors.

The first and/or the second sensor assembly can each be arranged to determine a rotational position or a rotational position of a pulley. In other words, the first and/or the second sensor assembly can each determine by how many degrees a pulley has rotated relative to a defined or imaginary zero position or starting position.

In one variant, the first and/or second sensor assemblies can determine a rotational position of the first and/or second pulley to an accuracy of 1.2 degrees, for example, whereby this measurement accuracy already includes the deviations from a technically ideal rotation of the pulleys due to the realized mechanics of the belt drive.

In one embodiment, at least part of the first sensor assembly can be integrated into the first pulley and/or coupled to the first pulley. Furthermore, at least part of the second sensor assembly can be integrated into the second pulley and/or coupled to the second pulley. For example, conductor loops and/or magnetic elements can be formed as part of the pulleys or coupled or connected to them.

Furthermore, the belt drive can comprise a data processing device or be associated with and/or connected to a data processing device. The data processing device may in particular be an electronic data processing device. In one variant, the data processing device may also be formed in whole or in part by the first and/or second sensor assembly and/or by a part of the first and/or second sensor assembly or be integrated therein. The data processing device can evaluate and store the acquisition of the first sensor assembly and/or the second sensor assembly and/or make the acquisitions and/or the evaluations accessible to an external technical device, for example an on-board computer. In a further development, the data processing device can be integrated into an on-board computer or be designed as part of an onboard computer.

Based on the detection of the first sensor assembly and the detection of the second sensor assembly, the data processing device can be configured to unambiguously determine a rotational position or setting position of the belt drive over a setting path of the belt drive comprising several complete rotations of the first and/or the second pulley.

This is made possible by the size or length ratio of the diameters of the first and second pulleys, which is different for each part. The length or size of the diameters of the pulleys implies the circumference of the pulleys and the transmission ratio of the belt drive with the two pulleys.

For example, if the first pulley has a diameter of 31 units of length and the second pulley has a diameter of 97 units of length, the transmission ratio for the belt drive is 97/31 or approximately 3.129 from the first, smaller, pulley to the second, larger, pulley. In other words, approximately 3.129 revolutions of the first, smaller, pulley result in one complete revolution of the second, larger, pulley. The reciprocal value results in a transmission ratio of 31/97 or approximately 0.3196 from the second, larger, pulley to the first, smaller, pulley. In other words, approximately 0.3196 revolutions of the second, larger, pulley result in one complete revolution of the first, smaller, pulley.

However, since the natural numbers 31 and 97 are not divisors, a specific rotational position or setting position of the belt drive, which is defined by a specific rotational position of the first pulley and a specific rotational position of the second pulley, is only repeated after 97 complete revolutions of the first pulley and 31 complete revolutions of the second pulley.

Each combination of a specific rotational position of the first pulley and a specific rotational position of the second pulley can therefore be uniquely assigned to a specific actuating position of the belt drive over an actuating path comprising several complete rotations of the first and/or second pulley.

The belt drive described here can be used, for example, for the steering of a motor vehicle. This can, for example, have an axis-parallel assembly with one of the belt drives described above. The belt drive can transmit a rotational movement from a first pulley arranged on an electric motor to a second pulley arranged on a ball screw drive, whereby the ball screw drive is configured to convert the rotational movement into a translational movement to effect or support the steering.

Known belt drives for the steering systems of motor vehicles have a travel of/with about 80 to 120 complete revolutions of the pulley on the motor side. In other words, approximately 80 to 120 complete revolutions of a pulley arranged on an electric motor can move a steering system for the motor vehicle from one maximum possible deflection position to the opposite maximum possible deflection position or at least support such a movement.

The number of maximum possible rotations of the belt drive pulleys between the maximum deflection positions defines the travel of the belt drive. If the size ratios of the pulleys are not chosen to be coprime, each combination of specific rotational positions of the two pulleys can be assigned to several possible belt drive positions on the travel, and thus several possible steering angles of the vehicle wheels. It is therefore not possible to clearly determine the current steering angle of the vehicle based solely on the rotational positions of the pulleys determined by the sensor assemblies.

However, if the size ratios of the pulleys are chosen to be coprime and matched to the length of the travel and/or to the maximum possible steering angle, each combination of specific rotational positions can be assigned to exactly one belt drive position and thus clearly to one steering angle of the vehicle wheels.

In one variant, the travel of the belt drive can be defined by 80 to 120, in particular 90 to 110, maximum possible complete revolutions of the first pulley in a specific direction of rotation. The second integer multiple of the unit length, which corresponds to the diameter of the second pulley, can be formed by the product of a natural number and the unit length, whereby the natural number can be greater than 80, in particular greater than 90 and/or greater than 100 and/or greater than 120.

The first pulley can be coupled to a motor or electric motor, in particular to the rotor of a brushless electric motor. Optionally, control or regulation of the motor or electric motor can also be based on the detection of the first sensor assembly. The brushless electric motor can be a permanently excited synchronous motor (PMSM) or a brushless asynchronous machine.

One advantage here is that the detection of the first sensor assembly can serve at least two different purposes, namely firstly to determine the position of the belt drive on the travel and/or to determine the steering angle of a steering system and secondly to regulate or control a motor or electric motor coupled to the belt drive. The control of the motor can, for example, include field-oriented control (FOC). On the one hand, this can save a sensor that is already required for regulating or controlling the motor and, on the other hand, an additional benefit can be derived from the sensor assemblies required for detecting the rotational position of the pulleys.

Furthermore, the belt drive can comprise a temperature sensor which is configured to detect a temperature of the belt drive, in particular a temperature of the environment of the belt. Alternatively or additionally, the belt drive can comprise a temperature estimator, which is configured to estimate a temperature of the belt drive, in particular a temperature of the belt's surroundings, based on a modeling of the belt drive.

One advantage here is that temperature compensation of the belt elasticity of the belt, in particular first or second order temperature compensation, can be carried out based on the detection of the temperature sensor and/or the temperature estimator.

Furthermore, the data processing device can be configured to determine a compression or elongation of the belt based on the detection of the first sensor assembly and the second sensor assembly and/or the temperature sensor and/or the temperature estimator. Alternatively or additionally, the data processing device can also be configured to determine a force acting on the belt drive, in particular on the belt, based on the detection of the first sensor assembly and the second sensor assembly and/or the temperature sensor and/or the temperature estimator.

One advantage here is that the first sensor assembly and the second sensor assembly, which can optionally be supplemented by a temperature sensor and/or a temperature estimator, can also interact to form a force sensor, for example a force sensor for the forces acting on the steering of a motor vehicle during operation of the motor vehicle. The acting forces can be determined by detected compressions or elongations of the belt and their comparison with predetermined and/or stored reference values.

In one embodiment, the data processing device is further configured to determine or estimate wear and/or damage to the belt drive, in particular the belt, based on current and/or recorded detections of the first sensor assembly and the second sensor assembly and/or the temperature sensor and/or the temperature estimator.

Determining the wear and/or damage can in particular comprise a comparison of the detections of the first sensor assembly and the second sensor assembly and/or the temperature sensor with a modeling of the belt. The modeling can in particular be a virtual modeling of the belt drive created by the, in particular electronic, data processing device, which models technical-physical properties of the belt drive, which are then compared by the data processing device with the actual detections of the first sensor assembly and the second sensor assembly and/or the temperature sensor.

Furthermore, the data processing device can be configured to determine and/or estimate undercooling and/or icing of the belt drive and/or a device coupled to the belt drive, in particular a ball screw drive, based on current and/or recorded detections of the first sensor assembly and the second sensor assembly and/or the temperature sensor and/or the temperature estimator.

Icing, for example icing of the ball screw drive, can occur, for example, if a motor vehicle with the belt drive comes into contact with water at negative ambient temperatures, for example in a car wash. Icing of the belt drive and/or a device coupled to the belt drive can have a significant negative impact on the road safety of the motor vehicle. Similar to wear and/or damage to the belt drive, undercooling and/or icing of the belt drive and/or a device coupled to the belt drive, in particular a ball screw drive, can also be determined by the data processing device by comparing the detections of the first sensor assembly and the second sensor assembly and/or the temperature sensor with a modeling of the belt. Here too, the modeling can in particular be a virtual modeling of the belt drive created by the, in particular electronic, data processing device, which models technical-physical properties of the belt drive, which are then compared by the data processing device with the actual detections of the first sensor assembly and the second sensor assembly and/or the temperature sensor.

The belt drive described above can in particular be part of an axis-parallel assembly or an axis-parallel drive, in particular for the steering of a motor vehicle. The belt drive and/or the axis-parallel assembly or the axis-parallel drive with the belt drive can furthermore be part of a motor vehicle, in particular part of the steering of a motor vehicle.

Optionally, the data processing device can also be set up to issue a warning message to the driver of a motor vehicle and/or to immobilize the motor vehicle based on the detection of wear and/or damage and/or undercooling and/or icing of the belt drive, in particular the belt, and/or with a device coupled to the belt drive, in particular a ball screw drive.

One advantage of this is that the driver of the motor vehicle can be notified of any foreseeable need for maintenance of the motor vehicle, for example with a visually and/or acoustically perceptible warning message, and that the vehicle can also be immobilized by the data processing device if a hazardous situation is detected.

A method for determining a rotational position of pulleys of a belt drive comprises the steps:
providing a first pulley with a first diameter;
providing a second pulley with a second diameter;
providing a belt which is arranged in each case on a lateral surface of the first and second pulleys and is configured to transmit a rotational movement of the first pulley to the second pulley;
detecting of a rotational position of the first pulley with a first sensor assembly;
detecting of a rotational position of the second pulley with a second sensor assembly; characterized in that

the first diameter corresponds to a first integer multiple of a unit length and the second diameter corresponds to a second integer multiple of the same unit length, wherein the first and second integer multiples of the unit length are different from each other and are coprime.

Furthermore, the method for determining a rotational position of pulleys of a belt drive can comprise the following steps:
providing a data processing device; and
unambiguously determining a rotational position or setting position of the belt drive over a setting path comprising several complete rotations of the first and/or the second pulley, based on the detection of the first sensor assembly and the detection of the second sensor assembly.

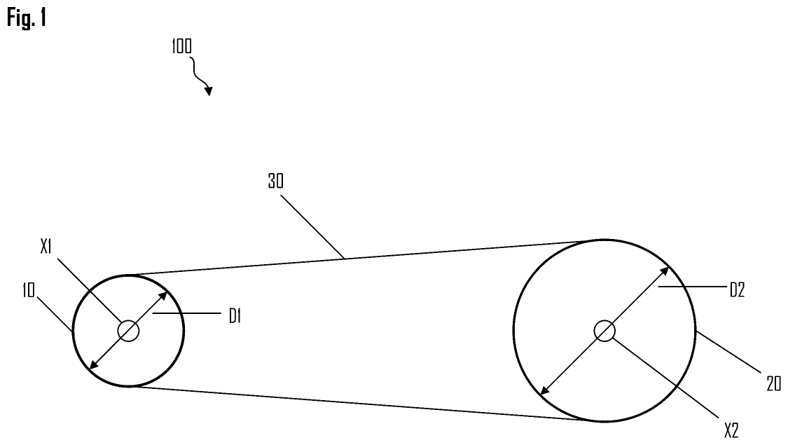

Further features, properties, advantages and possible modifications of the belt drive will become clear to a person skilled in the art from the following description, in which reference is made to the attached schematic drawing. The dimensions and proportions of the components shown in FIG. 1 are expressly not to scale.

FIG. 1 shows an example of a belt drive 100.

FIG. 1 shows an example of a belt drive 100 with a first pulley 10 and a second pulley 20. The first pulley 10 is mounted to rotate about a first axis of rotation X1 and the second pulley 20 is mounted to rotate about a second axis of rotation X2.

FIG. 1 also shows a belt 30, which is arranged in each case on a lateral surface of the first and second pulley 10, 20 and is configured to transmit a rotational movement of the first pulley 10 to the second pulley 20.

Furthermore, the pulleys 10, 20, which are expressly not shown to scale, have a size ratio that corresponds to the ratio of two natural numbers that are coprime.

The rotational position of the pulleys 10, 20 is detected in each case by a sensor assembly, each of which has at least one sensor. The rotational position of the first pulley is detected by a first sensor assembly (not shown) and the rotational position of the second pulley is detected by a second sensor assembly (not shown).

The first and second sensor assemblies are configured to determine a rotational position of the first pulley 10 and the second pulley 20. The first and second sensor assemblies determine by how many degrees the pulleys have each rotated relative to a predefined zero position.

The sensor assemblies forward the detected rotational positions of the pulleys 10, 20 in each case to an electronic data processing device (not shown). The data processing device uses the two rotational positions of the pulleys 10, 20 to determine an adjustment position of the belt drive over a setting path comprising several complete rotations of the first and second pulleys.

Since the size ratio of the pulleys 10, 20 corresponds to a ratio of two coprime numbers, a setting position of the belt drive, which comprises several complete rotations of the first pulley and the second pulley, is only repeated after a large number of complete rotations of the two pulleys. Only after the number of complete revolutions of the smaller pulley about its axis of rotation exceeds the amount of the larger natural number of the size ratio of the pulleys can a specific combination of the rotational position of the first pulley 10 with the rotational position of the second pulley 20 no longer be unambiguously assigned to a setting position of the belt drive on the setting path comprising several complete rotations of the first and second pulleys.

In the example shown, the maximum number of revolutions of the two pulleys 10, 20 is limited by external conditions in such a way that each combination of a rotational position of the first pulley 10 with a rotational position of the second pulley 20 can only be assigned to exactly one adjustment position of the belt drive 100.

Each combination of a specific rotational position of the first pulley 10 and a specific rotational position of the second pulley 20 can thus be uniquely assigned to a specific setting position of the belt drive 100 over the setting path comprising several complete rotations of the first and second pulleys.

The belt drive 100 shown can be used, for example, for the steering of a motor vehicle. This can, for example, have an axis-parallel assembly with one of the belt drives 100 described above. The belt drive 100 can transmit a rotational movement from a pulley arranged on an electric motor to a second pulley arranged on a ball screw drive, the ball screw drive being configured to convert the rotational movement into a translational movement to effect or support the steering.

If the belt drive 100 is used for the steering of a motor vehicle as outlined, each rotational position of the pulleys 10, 20 can be uniquely assigned to a position of the steering mechanism and thus to a toe angle of the wheels of the motor vehicle influenced by the steering. The position of the steering mechanism and/or the toe angle of the wheels of the motor vehicle influenced by the steering can thus be determined without further sensors within the steering mechanism and without a rotation history of the pulleys.

Optionally, the control of the motor coupled to a pulley, in particular an electric motor, can be based on the detection of one of the sensor assemblies that detect the rotational positions of the pulleys. This can eliminate the need for further sensors for electrically assisted or fully electric steering. In particular, the motor can be coupled to the first pulley 10 and controlled based on the detection of the first sensor assembly.

The variants of the device described above, as well as the construction and operating aspects thereof, are merely intended to provide a better understanding of the structure, mode of operation and properties; they do not limit the disclosure to the object shown in the drawing. The drawing is highly schematic, whereby essential properties and effects are in part shown clearly enlarged in order to clarify the functions, operating principles, technical embodiments and features.

The claims do not limit the disclosure and thus the possible combinations of all features described herein. All disclosed features are also explicitly disclosed individually and in combination with all other features herein.

1. A belt drive, comprising
a first pulley having a first diameter; and
a second pulley having a second diameter; and
a belt, which is arranged in each case on a lateral surface of the first and the second pulley and is configured to transmit a rotational movement of the first pulley to the second pulley;
a first sensor assembly which is arranged and configured to detect a rotational position of the first pulley; and
a second sensor assembly, which is arranged and configured to detect a rotational position of the second pulley, wherein
the first diameter corresponds to a first integer multiple of a unit length, and the second diameter corresponds to a second integer multiple of the same unit length, and
the first and second integer multiples of the unit length are different from each other and are coprime.

2. The belt drive according to claim 1, wherein
the first diameter and/or the second diameter correspond to a product of the unit length and a prime number.

3. The belt drive according to claim 1, wherein
the first sensor assembly comprises a contactless detecting position sensor, in particular a contactless and inductive detecting position sensor, and/or
the second sensor assembly comprises a contactless detecting position sensor, in particular a contactless and inductive detecting position sensor.

4. The belt drive according to claim 1, wherein
at least a part of the first sensor assembly is integrated into the first pulley and/or is coupled to the first pulley, and/or
at least part of the second sensor assembly is integrated into the second pulley and/or is coupled to the second pulley.

5. The belt drive according to claim 1, further comprising:
a data processing device which is configured to unambiguously determine, based on the detection of the first sensor assembly and the detection of the second sensor assembly, a rotational position or setting position of the belt drive on a setting path comprising a plurality of complete rotations of the first and/or the second pulley.

6. The belt drive according to claim 1, wherein
the first pulley is coupled to a motor or electric motor, in particular to the rotor of a brushless electric motor, and
a control or regulation of the motor or electric motor is based on the detection of the first sensor assembly.

7. The belt drive according to claim 1, further comprising:
a temperature sensor which is configured to detect a temperature of the belt drive, in particular a temperature of the environment of the belt, and/or
a temperature estimator which is configured to estimate a temperature of the belt drive, in particular a temperature of the environment of the belt, based on a modeling of the belt drive.

8. The belt drive according to claim 5, wherein
the data processing device is further configured to determine a compression or elongation of the belt based on the detection of the first sensor assembly and the second sensor assembly and/or the temperature sensor and/or the temperature estimator, and/or
the data processing device is further configured to determine a force acting on the belt drive, in particular on the belt, based on the detection of the first sensor assembly and the second sensor assembly and/or the temperature sensor and/or the temperature estimator.

9. The belt drive according to claim 5, wherein
the data processing device is further configured to determine or estimate wear and/or damage to the belt drive, in particular the belt, based on current and/or recorded detections of the first sensor assembly and the second sensor assembly and/or the temperature sensor and/or the temperature estimator.

10. The belt drive according to claim 5, wherein
the data processing device is further configured to determine and/or estimate undercooling and/or icing of the belt drive and/or a device coupled to the belt drive, in particular a ball screw drive, based on current and/or recorded detections of the first sensor assembly and the second sensor assembly and/or the temperature sensor and/or the temperature estimator.

11. An axis-parallel drive, comprising:
a belt drive according to claim 1.

12. A motor vehicle steering system for a motor vehicle, comprising:
a belt drive according to claim 1, and/or
an axis-parallel drive according to claim 11.

13. A motor vehicle steering system for a motor vehicle according to claim 12, wherein
the data processing device is further configured to issue a warning message to the driver of a motor vehicle and/or to immobilize the motor vehicle based on the detection of wear and/or damage and/or undercooling and/or icing of the belt drive, in particular the belt, and/or with a device coupled to the belt drive, in particular a ball screw drive.

14. A method of determining a rotational position of pulleys of a belt drive, comprising the steps of:
providing a first pulley with a first diameter;
providing a second pulley with a second diameter;
providing of a belt, which is arranged in each case on a lateral surface of the first and the second pulley and is configured to transmit a rotational movement of the first pulley to the second pulley;
detecting a rotational position of the first pulley with a first sensor assembly;
detection of a rotational position of the second pulley with a second sensor assembly, wherein
the first diameter corresponds to a first integer multiple of a unit length and the second diameter corresponds to a second integer multiple of the same unit length, and the first and second integer multiples of the unit length are different from each other and are coprime.

15. A method according to claim 14, further comprising the steps of:
providing a data processing device; and
unambiguously determining of a rotational position or setting position of the belt drive on a setting path comprising a plurality of complete rotations of the first and/or the second pulley, based on the detection of the first sensor assembly and the detection of the second sensor assembly.
